(19) United States
(12) Patent Application Publication
(10) Pub. No.: US 2026/0141687 A1
(43) Pub. Date: May 21, 2026

(54) DYNAMIC ADJUSTMENT OF ADAPTIVE FEATURE MAPS

(71) Applicant: QUALCOMM Incorporated, San Diego, CA (US)

(72) Inventors: Per CRONVALL, Linköping (SE); Gustav Nils Ture PERSSON, Ljungsbro (SE); Gustav Lars Henrik JAGBRANT, Linköping (SE)

(21) Appl. No.: 18/954,302

(22) Filed: Nov. 20, 2024

(51) Int. Cl. G06V 10/77; G06T 7/11; G06T 7/246; G06T 7/33; G06V 10/776; G06V 20/17; G06V 20/56

(52) U.S. Cl. CPC G06V 10/7715; G06T 7/11; G06T 7/248; G06T 7/337; G06V 10/776; G06V 20/17; G06V 20/56; G06T 2207/10032; G06T 2207/20081

(57) ABSTRACT

Systems and techniques are described herein for sensor feature projection. For example, a computing device can generate, using an encoder, a first plurality of image features from a first plurality of images of an environment; process the first plurality of image features to generate a first plurality of aerial view features, wherein each aerial view feature from the first plurality of aerial view features is associated with a respective region of the environment; generate a first mask associated with a first region of the environment and aerial view features of the first plurality of aerial view features; generate, using the encoder, a second plurality of image features from a second plurality of images of the environment; and process, using the first mask, one or more image features of the second plurality of image features to generate a second plurality of aerial view features associated with the first region.

### FIELD

The present disclosure generally relates to sensor data processing and mapping. For example, aspects of the present disclosure relate to systems and techniques for dynamic adjustment of adaptive feature maps (e.g., aerial view feature maps, such as birds eye view (BEV) feature map(s)).

### BACKGROUND

Increasingly, systems and devices (e.g., autonomous vehicles, such as autonomous and semi-autonomous cars, drones, mobile robots, mobile devices, extended reality (XR) devices, and other suitable systems or devices) include multiple sensors to gather information about the environment, as well as processing systems to process the information gathered, such as for route planning, navigation, collision avoidance, environment modelling/rendering, etc. One example of such a system is a localization system for XR devices and/or Advanced Driver Assistance System (ADAS) for a vehicle. In such systems, sensor data, such as images captured from one or more cameras, may be gathered, transformed, and analyzed to detect features and/or objects (e.g., targets). Detected features can be compared to features indicated on a map to determine where the device and/or vehicle is located. However, such systems may rely on perspective views of the environment and thus can be sensitive to sensor placement, occlusions, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for sensor feature projection is provided. The apparatus can include at least one memory and at least one processor coupled to the at least one memory. The processor can be configured to: generate, using an encoder, a first plurality of image features from a first plurality of images of an environment; process the first plurality of image features to generate a first plurality of aerial view features, wherein each aerial view feature from the first plurality of aerial view features is associated with a respective region of the environment; generate a first mask associated with a first region of the environment and one or more aerial view features of the first plurality of aerial view features; generate, using the encoder, a second plurality of image features from a second plurality of images of the environment; and process, using the first mask, one or more image features of the second plurality of image features to generate a second plurality of aerial view features associated with the first region.

In some aspects, an apparatus for sensor feature projection is provided. The apparatus can include at least one memory and at least one processor coupled to the at least one memory. The processor can be configured to: generate, using an encoder, a first plurality of image features from a first plurality of images of an environment; process the first plurality of image features to generate a first plurality of aerial view features; generate a first aerial view grid associated with the first plurality of aerial view features; and determine, based on an offset condition, a section of the first aerial view grid relevant to a vehicle associated with the apparatus to generate a second aerial view grid based on the section of the first aerial view grid.

In some aspects, a method for sensor feature projection is provided. The method can include: generating, using an encoder, a first plurality of image features from a first plurality of images of an environment; processing the first plurality of image features to generate a first plurality of aerial view features, wherein each aerial view feature from the first plurality of aerial view features is associated with a respective region of the environment; generating a first mask associated with a first region of the environment and one or more aerial view features of the first plurality of aerial view features; generating, using the encoder, a second plurality of image features from a second plurality of images of the environment; and processing, using the first mask, one or more image features of the second plurality of image features to generate a second plurality of aerial view features associated with the first region.

In some aspects, a method for sensor feature projection is provided. The method can include: generating, using an encoder, a first plurality of image features from a first plurality of images of an environment; processing the first plurality of image features to generate a first plurality of aerial view features; generating a first aerial view grid associated with the first plurality of aerial view features; and determining, based on an offset condition, a section of the first aerial view grid relevant to a vehicle associated with the apparatus to generate a second aerial view grid based on the section of the first aerial view grid.

In some aspects, a non-transitory computer-readable medium is provided having stored thereon instructions that, when executed by at least one processor, cause the at least one processor to: generate, using an encoder, a first plurality of image features from a first plurality of images of an environment; process the first plurality of image features to generate a first plurality of aerial view features, wherein each aerial view feature from the first plurality of aerial view features is associated with a respective region of the environment; generate a first mask associated with a first region of the environment and one or more aerial view features of the first plurality of aerial view features; generate, using the encoder, a second plurality of image features from a second plurality of images of the environment; and process, using the first mask, one or more image features of the second plurality of image features to generate a second plurality of aerial view features associated with the first region.

In some aspects, a non-transitory computer-readable medium is provided having stored thereon instructions that, when executed by at least one processor, cause the at least one processor to: generate, using an encoder, a first plurality of image features from a first plurality of images of an environment; process the first plurality of image features to generate a first plurality of aerial view features; generate a first aerial view grid associated with the first plurality of aerial view features; and determine, based on an offset condition, a section of the first aerial view grid relevant to a vehicle associated with the apparatus to generate a second aerial view grid based on the section of the first aerial view grid.

In some aspects, an apparatus for sensor feature projection is provided. The apparatus includes: means for generating, using an encoder, a first plurality of image features from a first plurality of images of an environment; means for processing the first plurality of image features to generate a first plurality of aerial view features, wherein each aerial view feature from the first plurality of aerial view features is associated with a respective region of the environment; means for generating a first mask associated with a first region of the environment and one or more aerial view features of the first plurality of aerial view features; means for generating, using the encoder, a second plurality of image features from a second plurality of images of the environment; and means for processing, using the first mask, one or more image features of the second plurality of image features to generate a second plurality of aerial view features associated with the first region.

In some aspects, an apparatus for sensor feature projection is provided. The apparatus includes: means for generating, using an encoder, a first plurality of image features from a first plurality of images of an environment; means for processing the first plurality of image features to generate a first plurality of aerial view features; generating a first aerial view grid associated with the first plurality of aerial view features; and means for determining, based on an offset condition, a section of the first aerial view grid relevant to a vehicle associated with the apparatus to generate a second aerial view grid based on the section of the first aerial view grid.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example image capture and processing system, in accordance with aspects of the present disclosure;

FIG. 2 illustrates an example implementation of a system-on-a-chip (SOC), in accordance with aspects of the present disclosure;

FIG. 3A illustrates an example of a fully connected neural network, in accordance with aspects of the present disclosure;

FIG. 3B illustrates an example of a locally connected neural network, in accordance with aspects of the present disclosure;

FIG. 3C illustrates an example of a convolutional neural network (CNN), in accordance with aspects of the present disclosure;

FIG. 3D is a diagram illustrating an example of a deep convolutional network (DCN) for recognizing visual features from an image, in accordance with some examples of the present disclosure;

FIG. 4 is a block diagram illustrating an example deep convolutional network (DCN), in accordance with some examples of the present disclosure;

FIG. 5 is a diagram illustrating an example of a vehicle with a sensor suite, according to various aspects of the present disclosure;

FIG. 6 illustrates a technique for generating bird's eye view (BEV) feature maps, in accordance with aspects of the present disclosure;

FIG. 7 is a technique for generating masks for BEV feature maps, in accordance with aspects of the present disclosure;

FIG. 8 is a flow diagram for training a machine learning model for generating masks, in accordance with aspects of the present disclosure;

FIG. 9 is a block diagram of a virtual BEV map with an applied mask, in accordance with aspects of the present disclosure;

FIG. 10 is a flow diagram for applying masks to BEV feature maps, in accordance with aspects of the present disclosure; and

FIG. 11 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As mentioned, systems and devices (e.g., autonomous vehicles, such as autonomous and semi-autonomous cars, drones, mobile robots, mobile devices, extended reality (XR) devices, and other suitable systems or devices) increasingly include multiple sensors (e.g., camera sensors) to gather information about the environment, as well as processing systems to process the information gathered, such as for route planning, navigation, collision avoidance, environment modelling/rendering, etc. Multi-view 3D object detectors can employ an aerial view model (e.g., a birds eye view (BEV) model) or a detection transformer model. The object detection models require high resolution input images and intermediate feature representations for maximal detection performance, which can result in a computationally expensive solution. Alternatively, downsampled input images (or low-resolution images from a lower-resolution sensor) and/or lower resolution feature representations can be used, but at the expense of detection performance.

A common technique for displaying the aerial view model is to represent the aerial view model as a bird's eye view (BEV) grid, also referred to as an aerial view grid. Features of the BEV grid can be captured using a device with sensors for gathering information about the environment. The longer the detection distance of the sensors, the larger the grid. Larger grids require higher computational costs to generate and populate with features of the environment. Further, subsequent processing steps using the larger grids incur higher computational costs.

Many BEV grids are static grids that have a fixed resolution, size, and position. When the BEV grid is a static grid, the BEV grid is often dimensioned to encompass a longest detection range scenario in all directions around the device to accommodate for a maximum number of scenarios in which the device can operate. In practice, this results in the device using the same detection distance in all directions during operation of the device. Devices that use sensors with the same sensor detection distance in all directions typically have computational costs that increase quadratically as the detection distance increases.

Not every region within the sensor detection distance is relevant to the device. For example, the device can be part of a vehicle that performs ADAS features, such as automatic parking assistance. In such an example, not every region of the environment includes features relevant to parking. For example, sensors of the device can detect a barrier and objects beyond the barrier. The objects beyond the barrier can be irrelevant to the device performing automatic parking assistance, at least because the barrier would prevent the vehicle from reaching the objects during parking. In current systems, the objects beyond the barrier are still captured by the sensors and transformed by the device into aerial view features of the objects (e.g., an aerial or BEV perspective representation of the objects). This is an inefficient result, because the aerial view features, also referred to as BEV features, of the objects beyond the barrier are not relevant to performing parking assistance. The device wastes computing resources by transforming sensor data, such as images from a camera, into aerial view features that are not relevant to the task performed by the device.

In some examples, regions of the environment can be irrelevant to the device, and therefore transforming sensor data associated with the regions into aerial view features is an inefficient use of computing resources. The irrelevant regions still contribute to the computational costs of operating the device because the device would still transform sensor data associated with the irrelevant regions into aerial view features. For example, regions behind structures such as buildings, fences, lane separators, etc., can still be mapped on the BEV grid, despite the sensor data at these locations being irrelevant to the device. The device can reduce computational resources by dimensioning the BEV grid such that the irrelevant features of the environment are not represented within the BEV grid. In further examples, the device can generate the BEV grid without including the irrelevant aerial view features.

Systems, apparatuses, electronic devices, methods (also referred to as processes), and computer-readable media (collectively referred to herein as “systems and techniques”) are described herein for generating dynamically dimensioned bird's eye view (BEV) grids. In some aspects, a BEV grid is a grid-based representation of an aerial view of a device and the environment in which the device is located. The device can use sensors to capture features associated with the environment. For example, the device can be part of a vehicle (e.g., an autonomous or semi-autonomous car, drone, mobile robot, etc.) using cameras, RADAR sensors, LIDAR sensors, sonar sensors, etc. to perform various operations.

The device can transform sensor data into aerial view features which represent an aerial perspective of the sensor data at an associated location (e.g., region of the environment within the sensor detection distance). For example, the device can receive a plurality of images associated with the environment in which the device is located. The device can include an encoder (e.g., a machine learning encoder, such as a neural network encoder) that can process the plurality of images to generate image features associated with objects within the environment. The device can use the encoder, a machine learning model, or program to transform the image features into aerial view features representing an aerial view perspective of the object within the image. The aerial view features can be represented within a BEV grid.

The device can provide the aerial view features to a mask generator. The mask generator can be a machine learning model to determine regions and aerial view features that are not relevant to the operation of the device. The mask generator generates a mask that represents regions of the environment in which aerial view features should not be generated. The device applies the mask when transforming a subsequent set of sensor data (e.g., a subsequent plurality of images and image features) into aerial view features to transform the aerial view features that are not in the irrelevant regions.

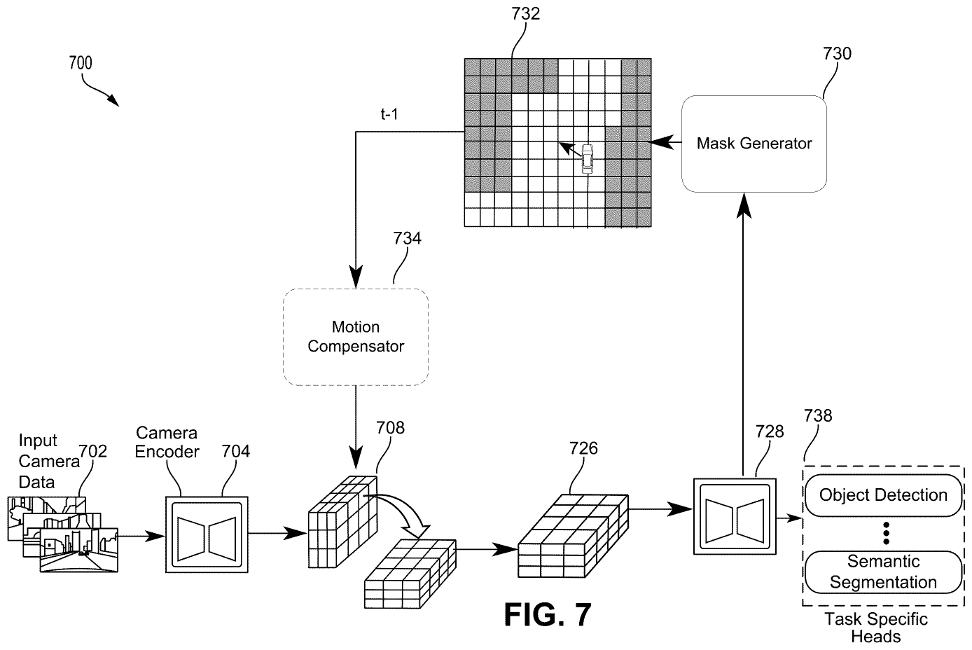

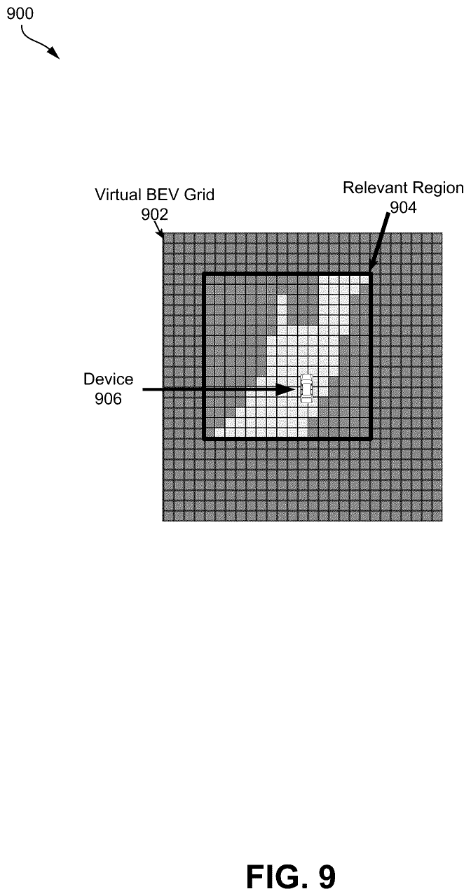

In some examples, the mask generator can use additional information in generating masks, such as offset conditions. Offset conditions can be conditions set by a user or the device that adjusts which regions of the environment, relative to the position of the device, are determined to be relevant. For example, an offset condition can include information or instructions that the regions in front of the device (e.g., regions in front of a car, the direction the device is facing) is more relevant and the regions behind the device are less relevant. The offset condition can cause the mask generator to determine that more aerial view features should be generated in front of the device than aerial view features generated behind the device. When displayed in a BEV grid, this can be shown as the device being represented as an icon at an offset location (e.g., offset from a center point of the BEV grid). For example, because the mask generator can determine that more aerial view features should be generated in front of the device than behind the device, the BEV grid can include more cells in portions of the BEV associated with regions in front of the device than the number of cells associated with regions behind the device. FIG. 7 and FIG. 9 provide a visual representation of BEV grids.

In some examples, the offset condition can be determined by the mask generator based on the location of irrelevant regions relative to the device. For example, when the mask generator determines that all regions to the right of the device are irrelevant (e.g., when the regions to the right of the device are blocked by an object), the mask generator can generate an offset condition that shifts the positioning of the BEV grid such that the center is not associated with the location of the device.

In some examples, the device can adjust the offset condition and BEV grid dimensions based on the movement of the device. For example, when the device is part of a vehicle traveling in reverse, the offset condition can indicate that the image features behind the vehicle should be transformed into the BEV space at greater distances than the image features in front of the vehicle. In further examples, the offset condition can adjust based on changes in velocity of the device. For example, a device traveling at higher speeds can generate a BEV grid with aerial view features represented at greater distances than a device traveling at lower speeds (e.g., a larger BEV grid for faster moving devices and a smaller BEV grid for slower moving devices).

Various aspects of the present disclosure will be described with respect to the figures.

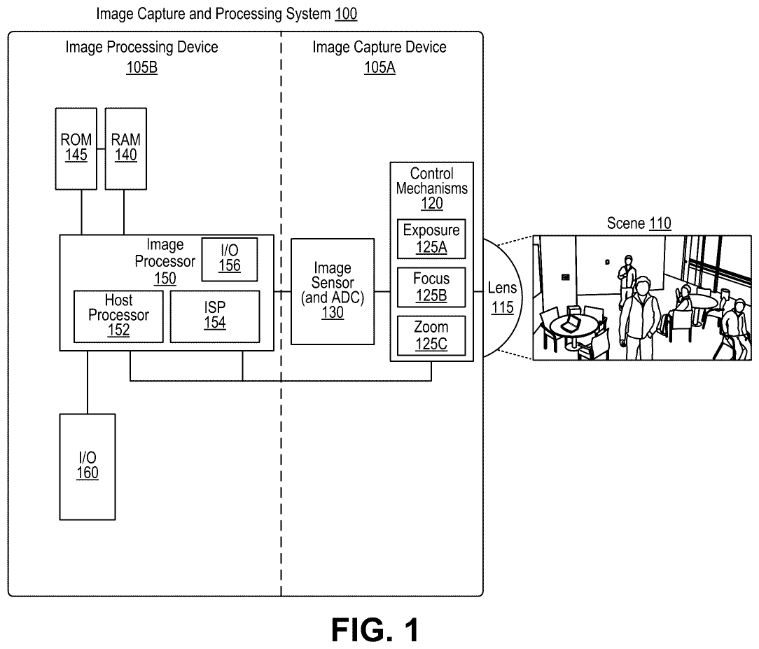

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses can be included in the image capture and processing system 100, such as one or more microlenses over each photodiode of the image sensor 130, which each bend the light received from the lens 115 toward the corresponding photodiode before the light reaches the photodiode. The focus setting can be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective covers that block light from reaching certain photodiodes, or portions of certain photodiodes, at certain times and/or from certain angles. In some cases, opaque and/or reflective covers may be used for phase detection autofocus (PDAF). In some cases, the opaque and/or reflective covers may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

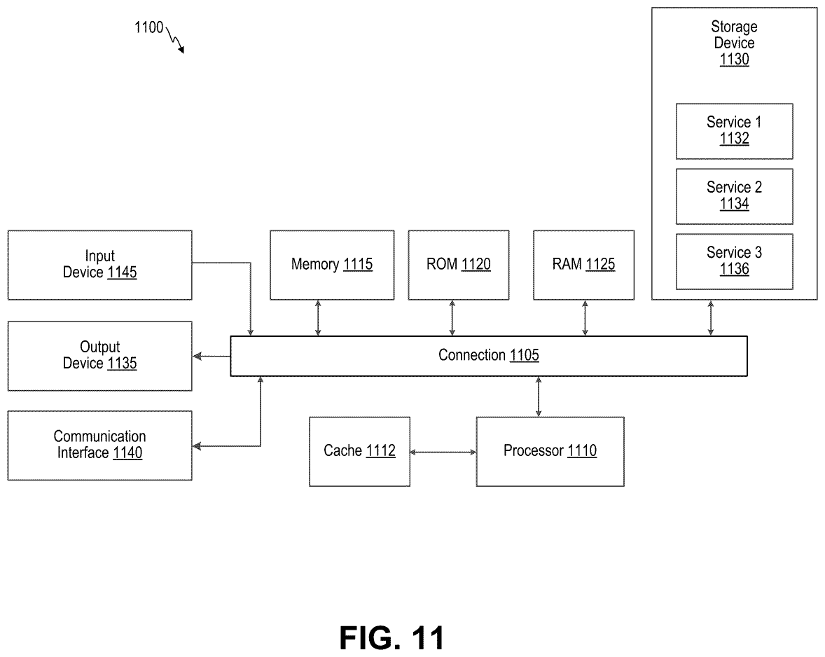

The image processor 150 may include one or more processors, such as one or more image signal processors (ISPs) (including ISP 154), one or more host processors (including host processor 152), and/or one or more of any other type of processor 1110 discussed with respect to the computing system 1100 of FIG. 11. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., BluetoothTM, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

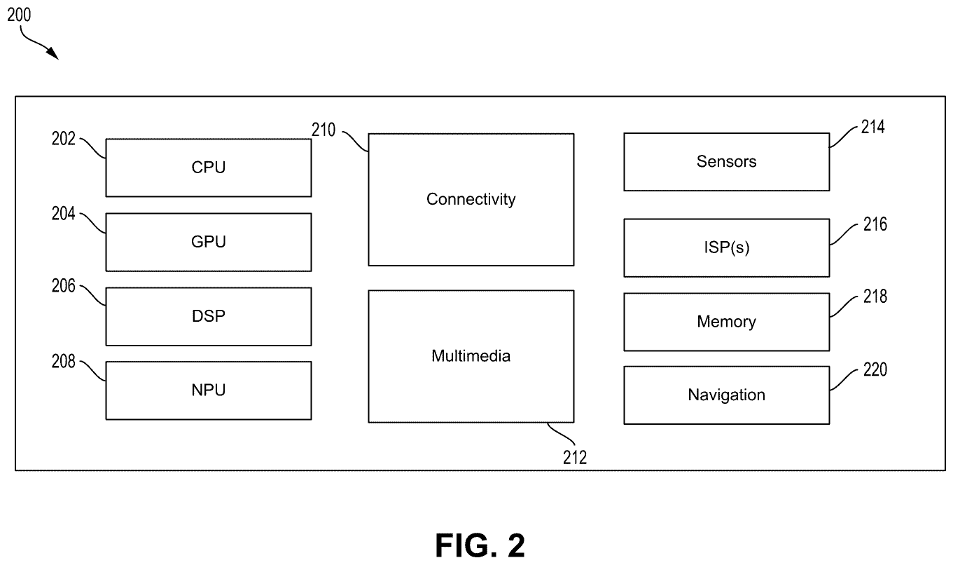

In some examples, the system-on-a-chip (SOC) 200 of FIG. 2 can include the image capture and processing system 100, the image capture device 105A, the image processing device 105B, or a combination thereof.

FIG. 2 illustrates an example implementation of a system-on-a-chip (SOC) 200, which may include a central processing unit (CPU) 202 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 208, in a memory block associated with a CPU 202, in a memory block associated with a graphics processing unit (GPU) 204, in a memory block associated with a digital signal processor (DSP) 206, in a memory block 218, and/or may be distributed across multiple blocks. Instructions executed at the CPU 202 may be loaded from a program memory associated with the CPU 202 or may be loaded from a memory block 218.

The SOC 200 may also include additional processing blocks tailored to specific functions, such as a GPU 204, a DSP 206, a connectivity block 210, which may include fifth generation (5G) connectivity, fourth generation long term evolution (4G LTE) connectivity, Wi-Fi connectivity, USB connectivity, Bluetooth connectivity, and the like, and a multimedia processor 212 that may, for example, detect and recognize gestures. In one implementation, the NPU is implemented in the CPU 202, DSP 206, and/or GPU 204. The SOC 200 may also include a sensor processor 214, image signal processors (ISPs) 216, and/or navigation module 220, which may include a global positioning system. The SOC 200 may be based on an ARM instruction set. SOC 200 and/or components thereof may be configured to perform segmentation mask extrapolation.

In some cases, the SOC 200 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer is defined by a set of weights, in the form of filters, kernels, etc. Each layer provides an output in the form of activation or feature maps. In some cases, a deep learning network can have a series of many hidden layers, with early layers being used to determine simple and low-level characteristics of an input, and later layers building up a hierarchy of more complex and abstract characteristics.

In some cases, sensor data, such as images captured by the image capture and processing system 100, point clouds captured by LIDAR/RADAR sensors, etc., may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

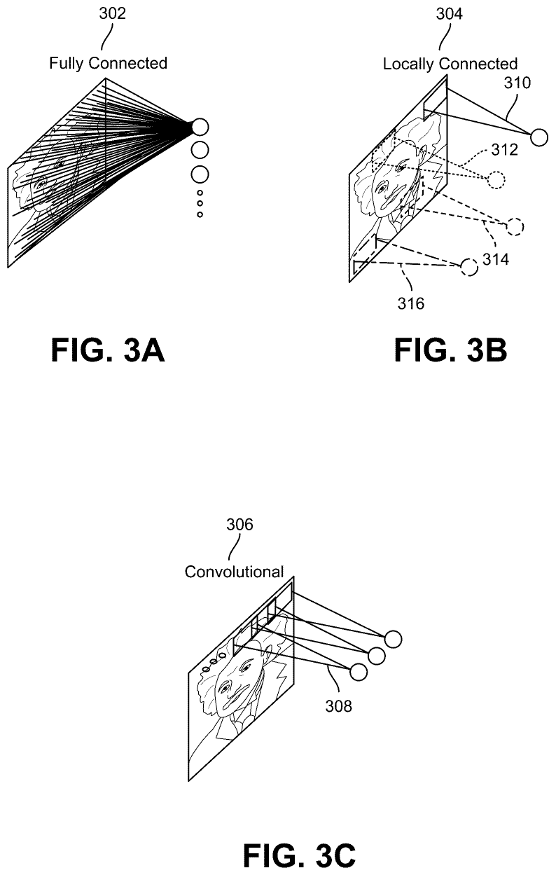

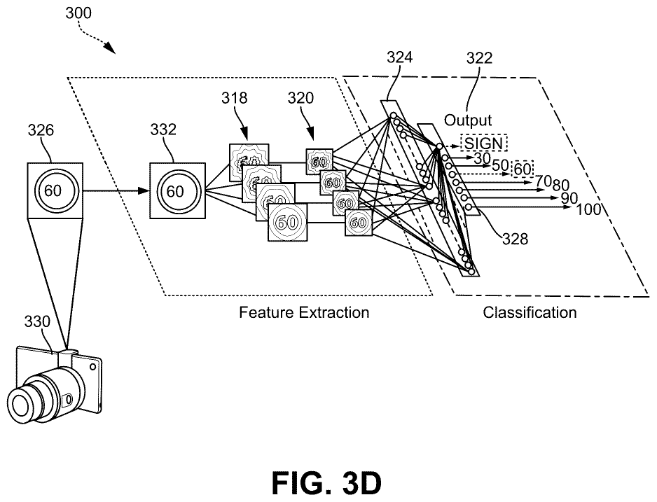

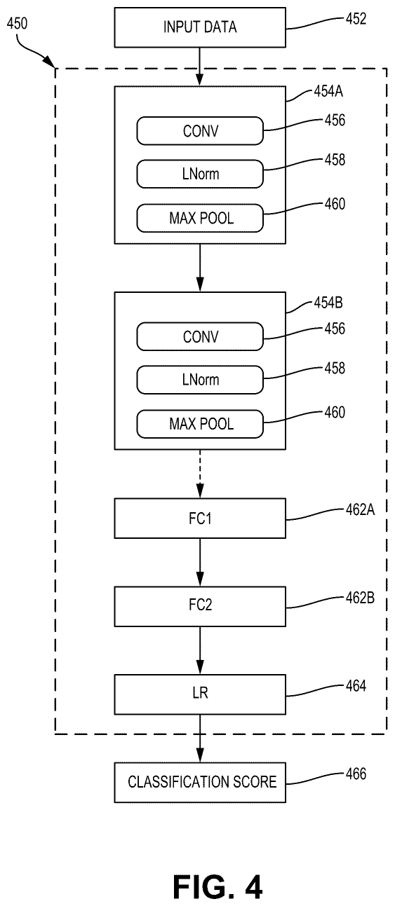

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 3A-FIG. 4.

The connections between layers of a neural network may be fully connected or locally connected. FIG. 3A illustrates an example of a fully connected neural network 302. In a fully connected neural network 302, a neuron in a first layer may communicate its output to every neuron in a second layer, so that each neuron in the second layer will receive input from every neuron in the first layer. FIG. 3B illustrates an example of a locally connected neural network 304. In a locally connected neural network 304, a neuron in a first layer may be connected to a limited number of neurons in the second layer. More generally, a locally connected layer of the locally connected neural network 304 may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 3C illustrates an example of a convolutional neural network 306. The convolutional neural network 306 may be configured such that the connection strengths associated with the inputs for each neuron in the second layer are shared (e.g., 308). Convolutional neural networks may be well suited to problems in which the spatial location of inputs is meaningful. Convolutional neural network 306 may be used to perform one or more aspects of video compression and/or decompression, according to aspects of the present disclosure.

One type of convolutional neural network is a deep convolutional network (DCN). FIG. 3D illustrates a detailed example of a DCN 300 designed to recognize visual features from an image 326 input from an image capturing device 330, such as an image capture and processing system 100 of FIG. 1. The DCN 300 of the current example may be trained to identify traffic signs and a number provided on the traffic sign. Of course, the DCN 300 may be trained for other tasks, such as identifying lane markings or identifying traffic lights.

The DCN 300 may be trained with supervised learning. During training, the DCN 300 may be presented with an image, such as the image 326 of a speed limit sign, and a forward pass may then be computed to produce an output 322. The DCN 300 may include a feature generation (or extraction) section and a classification section. Upon receiving the image 326, a convolutional layer 332 may apply convolutional kernels (not shown) to the image 326 to generate a first set of feature maps 318. As an example, the convolutional kernel for the convolutional layer 332 may be a 5×5 kernel that generates 28×28 feature maps. In the present example, because four different feature maps are generated in the first set of feature maps 318, four different convolutional kernels were applied to the image 326 at the convolutional layer 332. The convolutional kernels may also be referred to as filters or convolutional filters.

The first set of feature maps 318 may be subsampled by a max pooling layer (not shown) to generate a second set of feature maps 320. The max pooling layer reduces the size of the first set of feature maps 318. That is, a size of the second set of feature maps 320, such as 14×14, is less than the size of the first set of feature maps 318, such as 28×28. The reduced size provides similar information to a subsequent layer while reducing memory consumption. The second set of feature maps 320 may be further convolved via one or more subsequent convolutional layers (not shown) to generate one or more subsequent sets of feature maps (not shown).

In the example of FIG. 3D, the second set of feature maps 320 is convolved to generate a first feature vector 324. Furthermore, the first feature vector 324 is further convolved to generate a second feature vector 328. Each feature of the second feature vector 328 may include a number that corresponds to a possible feature of the image 326, such as “sign,” “60,” and “100.” A softmax function (not shown) may convert the numbers in the second feature vector 328 to a probability. As such, an output 322 of the DCN 300 is a probability of the image 326 including one or more features.

In the present example, the probabilities in the output 322 for “sign” and “60” are higher than the probabilities of the others of the output 322, such as “30,” “40,” “50,” “70,” “80,” “90,” and “100”. Before training, the output 322 produced by the DCN 300 is likely to be incorrect. Thus, an error may be calculated between the output 322 and a target output. The target output is the ground truth of the image 326 (e.g., “sign” and “60”). The weights of the DCN 300 may then be adjusted so the output 322 of the DCN 300 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 322 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 320) receiving input from a range of neurons in the previous layer (e.g., feature maps 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 4 is a block diagram illustrating an example of a deep convolutional network 450. The deep convolutional network 450 may include multiple different types of layers based on connectivity and weight sharing. As shown in FIG. 4, the deep convolutional network 450 includes the convolution blocks 454A, 454B. Each of the convolution blocks 454A, 454B may be configured with a convolution layer (CONV) 456, a normalization layer (LNorm) 458, and a max pooling layer (MAX POOL) 460. Of note, the layers illustrated with respect to convolution blocks 454A and 454B are examples of layers that may be included in a convolution layer and are not intended to be limiting and other types of layers may be included in any order.

The convolution layers 456 may include one or more convolutional filters, which may be applied to the input data 452 to generate a feature map. Although only two convolution blocks 454A, 454B are shown, the present disclosure is not so limiting, and instead, any number of convolution blocks (e.g., convolution blocks 454A, 454B) may be included in the deep convolutional network 450 according to design preference. The normalization layer 458 may normalize the output of the convolution filters. For example, the normalization layer 458 may provide whitening or lateral inhibition. The max pooling layer 460 may provide down sampling aggregation over space for local invariance and dimensionality reduction.

The parallel filter banks, for example, of a deep convolutional network may be loaded on a processor such as a CPU or GPU, or any other type of processor 1110 discussed with respect to the computing system 1100 of FIG. 11 to achieve high performance and low power consumption. In alternative aspects, the parallel filter banks may be loaded on a DSP or an ISP of the computing system 1100 of FIG. 11. In addition, the deep convolutional network 450 may access other processing blocks that may be present on the computing system 1100 of FIG. 11, such as sensor processor and navigation module, dedicated, respectively, to sensors and navigation.

The deep convolutional network 450 may also include one or more fully connected layers, such as layer 462A (labeled “FC1”) and layer 462B (labeled “FC2”). The deep convolutional network 450 may further include a logistic regression (LR) layer 464. Between each layer 456, 458, 460, 462A, 462B, 464 of the deep convolutional network 450 are weights (not shown) that are to be updated. The output of each of the layers (e.g., 456, 458, 460, 462A, 462B, 464) may serve as an input of a succeeding one of the layers (e.g., 456, 458, 460, 462A, 462B, 464) in the deep convolutional network 450 to learn hierarchical feature representations from input data 452 (e.g., images, audio, video, sensor data and/or other input data) supplied at the first of the convolution blocks 454A. The output of the deep convolutional network 450 is a classification score 466 for the input data 452. The classification score 466 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 450 may output probabilities that an input data, such as an image, includes certain features. The deep convolutional network 450 may then be modified to generate or extract (e.g., output) certain features from the input data. Additionally, DCNs may be added to generate or extract other features as well. This set of DCNs may function as encoders/feature extractors to identify or generate features in an image. In some cases, encoders/feature extractors may be used as a backbone for additional ML network components to perform further operations, such as localization, image segmentation, object detection, etc.

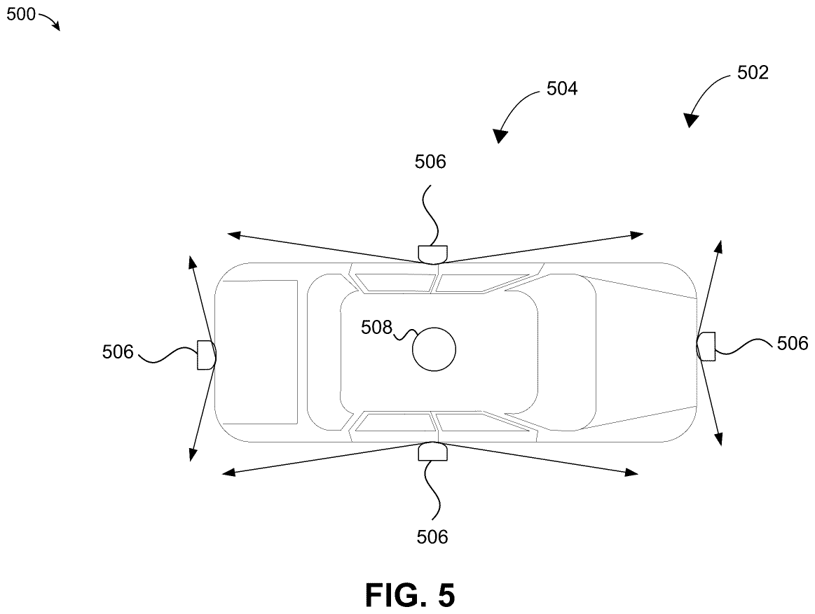

FIG. 5 is a diagram illustrating an example of a vehicle (e.g., an autonomous vehicle) 502 with a sensor suite 504. The source sensor suite 504 is shown to include four cameras 506 and one Light Detection and Ranging (LIDAR) sensor 508. Each of the cameras 506 may be a surround view (SV) camera or a fisheye camera, for example, with a wide (e.g., nearly 180 degree) field of view. The LIDAR sensor 508 may be a 64-layer LIDAR sensor. In one or more examples, the source sensor suite 504 of the source vehicle 502 may include a greater or lower number of cameras 506 and/or LIDAR sensors 508, than as shown in FIG. 5.

Collectively, the source sensor suite 504 may have certain intrinsic parameters (e.g., focal lengths of the cameras 506, optical centers of the cameras 506, skew coefficients of the cameras 506, frame-capture rates of the cameras 506, scan patterns of the LIDAR sensor 508, and/or intensity channels of the LIDAR sensor 508) and certain extrinsic parameters (e.g., positions of the cameras 506 and the LIDAR sensor 508 on source vehicle 502).

Data from at least a portion of the source sensor suite 504 may be used to train machine-learning models to perform specific tasks such as three dimensional (3D) and/or bird's eye view (BEV) tasks, for instance: 3D lane detection, 3D object detection (e.g., traffic-light detection, and/or sign detection), and/or two-dimensional (2D) perspective-view (PV) tasks for instance: image-based lane detection and/or 2D object detection and/or other tasks.

As previously mentioned, increasingly systems and devices (e.g., autonomous vehicles, such as autonomous and semi-autonomous cars, drones, mobile robots, mobile devices, extended reality (XR) devices, and other suitable systems or devices) employ multiple sensors (e.g., camera sensors) to gather information about the environment, as well as processing systems to process the information gathered, such as for route planning, navigation, collision avoidance, environment modelling/rendering, etc. An example of such a system is a multi-view 3D object detector. Typical current state-of-the-art multi-view 3D object detectors employ either a bird's eye view (BEV) model or a detection transformer model. To achieve maximal performance, these object detection models need high resolution input images and intermediate feature representations, which can lead to a computationally expensive solution. Alternatively, downsampled input images and/or lower resolution feature representations may be used, but at the expense of detection performance. Therefore, improved systems and techniques for efficient multi-view 3D object detection can be useful.

In one or more examples, during operation of the systems and techniques for detecting one or more objects, a device (e.g., a vehicle, such as an autonomous vehicle) may downsample one or more images of an environment of the device to produce one or more downsampled images. An encoder of the device may generate or extract a plurality of features from the one or more downsampled images. A detector of the device may then determine, based on the plurality of features, a detection of the one or more objects and 3D coordinates (e.g., world coordinates) for the one or more objects. The device may back-project the 3D coordinates of the one or more objects onto the one or more images. The device can determine one or more regions (e.g., each in the form of a bounding box) of at least one first image of the one or more images, based on the back-projection of the 3D coordinates of the one or more objects.

In one or more examples, the one or more images may have a higher resolution than the one or more downsampled images. In some examples, the one or more images may include a larger number of images than the one or more downsampled images. In one or more examples, the one or more images may be 2D images. In some examples, the device may project the plurality of features to a bird's eye view (BEV). In some examples, the 3D coordinates may be world coordinates. In one or more examples, the device may be a vehicle, such as an autonomous vehicle or an ego vehicle.

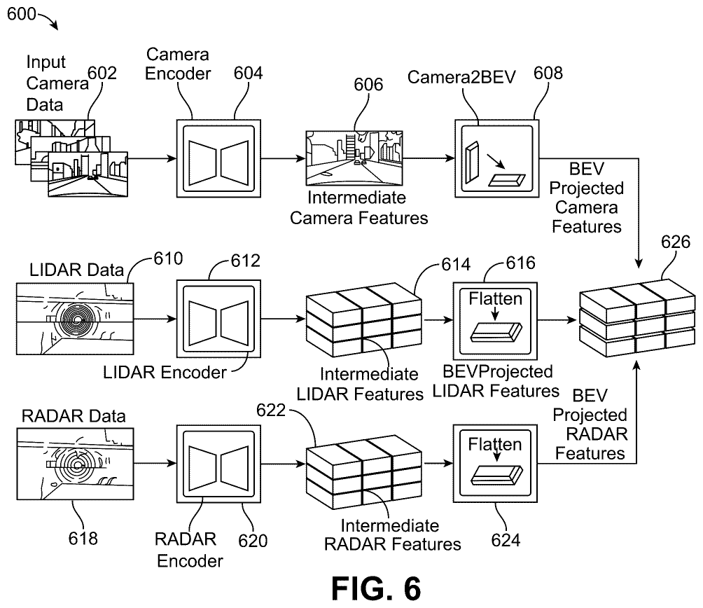

FIG. 6 illustrates a technique 600 for generating BEV feature maps 626 (also referred to as aerial view feature maps), in accordance with aspects of the present disclosure. The BEV feature maps 626 can be represented as a BEV grid. In technique 600, input camera data 602 (e.g., images captured by cameras) can be input to a camera data encoder 604. The camera data encoder 604 may include one or more encoders (also referred to as feature extractors). The encoder(s) may be ML based and can be used to generate or identify certain features in the camera data. As an example, the encoder(s) may include one or more layers or transformer blocks which may generate feature maps that include certain features generated or extracted from the camera data. The camera data encoder 604 may output the identified features as intermediate camera features 606 (e.g., image features of the input camera data 602). In some cases, the input camera data 602 and camera data encoder 604 may operate in a 2D space (e.g., on a height and width axes with respect to the camera). A perspective transformation 608 may be applied to the output intermediate camera features which converts the intermediate camera features from, for example, a frontal view of an environment from a vehicle to BEV projected camera features (e.g., aerial view projected camera features) as if features were generated based on a camera positioned above the vehicle. In some cases, the perspective transformation 608 can be ML based.

In some cases, LIDAR data 610 may be received, for example as a LIDAR point cloud, captured by a LIDAR. LIDAR may transmit a beam of ultraviolet, visible, or near infrared light into an environment and detects reflections of the beam from objects in the environment. Based on an amount of time needed for the reflections to be detected, distances to objects in the environment may be determined and LIDAR points may be described based on the point's location on a width, height, and depth axes with respect to the LIDAR. Thus, the LIDAR data is three-dimensional data. The LIDAR data 610 may be input to a LIDAR data encoder 612. The LIDAR data encoder 612 may be similar to the camera data encoder 604, but configured (e.g., trained) to operate in a 3D space to identify features in the LIDAR data and output the identified features as intermediate LIDAR features 614. The intermediate LIDAR features 614 may then be flattened 616 to BEV projected LIDAR features, for example, by removing or averaging the height information (e.g., height axes, height channel, height dimension).

In some cases, input RADAR data 618 may be received, for example, as a RADAR point cloud, captured by a RADAR. In some cases, RADAR operates in a manner similar to LIDAR, but uses radio frequency waves rather than light. The input RADAR data 618 may be input to a RADAR data encoder 620. The RADAR data encoder 620 may be similar to the LIDAR data encoder 612 and the RADAR data encoder 620 may identify features in the RADAR data and output the identified features as intermediate RADAR features 622. The intermediate RADAR features 622 may then be flattened 624 to BEV projected RADAR features, for example, by removing or averaging the height information (e.g., height axes, height channel, height dimension).

The BEV projected camera features, BEV projected LIDAR features, and BEV projected RADAR features may be combined into a set of multimodal BEV feature maps 626, for example, by combining the BEV projected camera features, the BEV projected LIDAR features, and the BEV projected RADAR features. In some cases, the BEV projected features may be combined by concatenating the BEV projected camera features, the BEV projected LIDAR features, and the BEV projected RADAR features.

The BEV feature maps can be used by a mask generator to generate a mask indicating regions of the environment not relevant to the device. For example, aerial view features associated with regions of the environment that are obstructed or otherwise inaccessible by a vehicle associated with the device can be irrelevant to the device. The device can save computational power by determining not to generate aerial view features for image features (or other features captured by sensors of the device) associated with regions of the environment irrelevant to the device.

FIG. 7 illustrates a technique 700 for generating masks for BEV feature maps using input camera data 702 (e.g., images captured by a camera associated with a device). This technique can be performed using devices such as the system-on-a-chip (SOC) 200 of FIG. 2 and the computing device architecture of FIG. 11. As described in the description of FIG. 6, sensor data from additional sensors can be provided in addition to or instead of the camera data 702. In technique 700, input camera data 602 (e.g., images captured by cameras) can be input to a camera data encoder 704. The camera data encoder 704 can include one or more encoders (or feature extractors). The encoders can be machine learning (ML) based and can be used to identify image features in camera data. As an example, the encoder(s) may include one or more layers or transformer blocks, such as the layers further described in the description of FIG. 4, for processing images to determine or generate features representing the images. The camera data encoder 704 can output the identified features as image features of the input camera data 702.

The technique 700 can include applying a perspective transformation 708 to the image features to convert the image features from a frontal view or other perspective views of an environment to BEV features (e.g., a top-down view as if the camera was positioned above the vehicle). In some cases, the perspective transformation 708 can be machine learning based (e.g., performed by a machine learning model). The technique 700 can include mapping the perspective features into a BEV grid to generate a BEV feature map 726.

In some examples, the technique 700 can include providing the BEV feature map 726 (e.g., including aerial view features) as input for subsequent network layers, shown in FIG. 7 as a BEV encoder/decoder 728. The BEV encoder/decoder 728 can provide the aerial view features and BEV feature map 726 to task specific heads 738 and a mask generator 730. The task specific heads 738 can utilize the BEV feature maps 726 (e.g., including the aerial view features) to perform operations such as object detection and semantic segmentation. Further examples include applications to perform ADAS operations such as lane detection, automatic parking assistance, etc.

The mask generator 730 generates a mask 732 representing regions of the environment in which aerial view features should not be generated. The mask generator 730 can be a machine learning model. In some examples, the mask generator 730 receives an offset condition as an input in addition to the aerial view features or BEV feature map 726. In some examples, the mask generator 730 can generate the offset condition based on the aerial view features the mask generator 730 determines are relevant.

In some examples, the mask can be a BEV grid with cells associated with irrelevant regions removed, empty, grayed out, or otherwise marked indicating that the cells should not be populated with aerial view features. For example, the mask can be a two-dimensional (2D) Boolean matrix. Each cell of the Boolean matrix can indicate (e.g., using a value, such as a value of 0 or 1) whether the aerial view features in the corresponding position of the BEV grid should be generated or not. In some examples, the mask 732 can include instructions to be applied during the perspective transformation 708 not to transform image features associated with the irrelevant regions of the BEV grid.

The mask output by the mask generator 730 is applied to a perspective transformation 708 subsequent to the perspective transformation associated with the BEV feature map 726 used to generate the mask. For example, the mask generated by the mask generator 730 can represent a mask associated with a time step t−1 to be applied to a perspective transformation 708 at time step t.

In some examples, the technique 700 can include adjusting the mask based on motion of a device associated with the input camera data 702. The technique 700 can use a motion compensator 734 to adjust the mask based on motion of the device. In some examples, the motion compensator 734 is a program or application for adjusting the mask based on the motion of the device. In further examples, the motion compensator 734 is part of the mask generator 730. For example, the device can be part of a vehicle such as an autonomous or semi-autonomous vehicle. The motion compensator can 734 align the mask 732 from a previous frame of the input camera data 702 with a subsequent frame of the input camera data 702 to compensate for motion of the vehicle through an environment. For example, the motion compensator 734 can translate and rotate the contents of the mask 732 based on the motion of the vehicle to align the mask 732 with subsequent frames of the input camera data 702. By using the ego-motion of the vehicle, the contents of the mask 732. When the vehicle is traveling at a higher velocity, the technique 700 can include adjusting the mask to include regions at further distances in the direction of the velocity of the vehicle as within relevant regions. In further examples, when the vehicle changes directions (e.g., the vehicle traveling in reverse), the technique 700 can include adjusting the mask to include relevant regions at further distances in the changed direction.

The perspective transformation 708 can use the mask and offset condition associated with time step t−1 for input camera data 702 associated with time step t to generate aerial view features for relevant regions of the environment. The technique 700 can be iterative, with each mask generated by the mask generator 730 used for the perspective transformation 708 of the input camera data 702 associated with a subsequent time step.

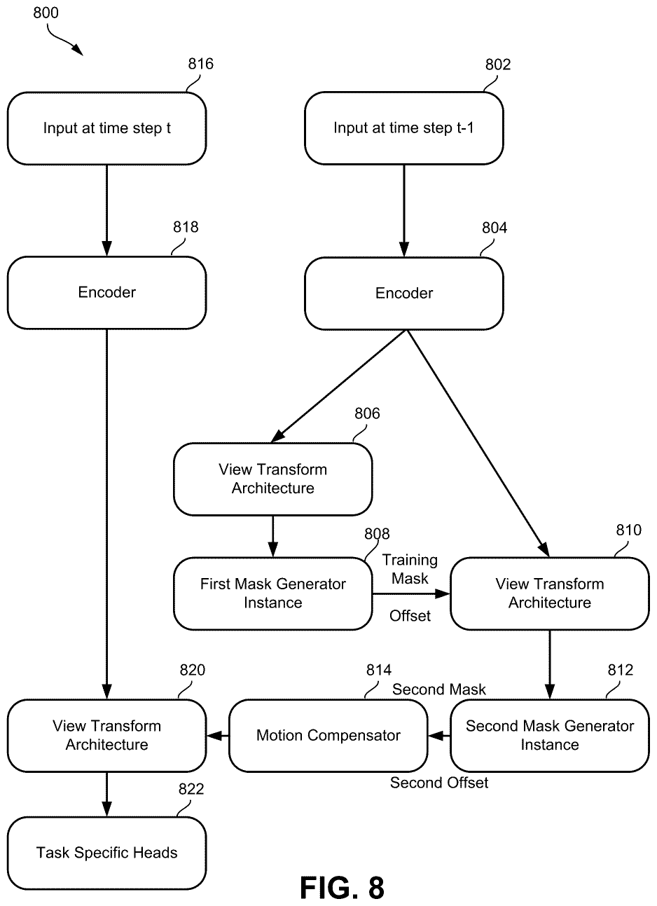

FIG. 8 is a flow diagram 800 for training a machine learning model for generating masks. The training process includes using two instances of a mask generator with different parameters and comparing outputs of the two instances. Based on the comparison, the weights of the machine learning model can be adjusted to minimize a loss function associated with the machine learning model.

The training process can begin at block 802 with the machine learning model receiving sensor inputs associated with time step t−1. For example, the sensor data can be images from a camera. The sensor data is provided to an encoder 804.

The encoder 804 can generate (or extract) features from the sensor data. The encoder can include the camera data encoder 604, LIDAR data encoder 612, or RADAR data encoder 620 from FIG. 6. For example, when the sensor data is a plurality of images, the encoder can process the input images (e.g., every input image, a subset of the input images, etc.) to generate features representing the image data of the input images.

The training process can include providing the output of the encoder (e.g., the features generated from the sensor data) to a view transform architecture 806 and 810. The view transform architecture 806 and 810 can include the architecture used to perform the perspective transformation 608 and 708 from FIG. 6 and FIG. 7. For example, the view transform architecture can be a program, application, or machine learning model for transforming generated or extracted sensor features into a first set of aerial view features (e.g., a first set of BEV features).

The first set of aerial view features output by the view transform architecture 806 are output to a first instance of a mask generator 808. The first instance of the mask generator can generate a training mask associated with the first set of aerial view features. The first instance of the mask generator 808 receives the first set of aerial view features associated with all of the sensor data received (e.g., the view transform architecture 806 can transform all of the received sensor data into the first aerial view features because no mask is applied to the view transform architecture 806 adjusting which sensor data can be transformed). In some cases, the first instance of the mask generator 808 can generate the training mask associated with the maximum detection range of the sensors that collected the sensor data because the first set of aerial view features is based on the sensor data received at block 802. The first instance of the mask generator 808 determines a region of the environment that is relevant to a current scene. The first instance of the mask generator 808 can determine, within the region, sub-regions that are relevant or irrelevant. The first instance of the mask generator 808 generates a training mask associated with the region including instructions for the view transform architecture 810 to not transform sensor features associated with the irrelevant regions into aerial view features.

The first instance of the mask generator 808 can output an offset condition. In some examples, the offset condition is based on the relative position of a device associated with the sensor data and the sub-regions of the environment determined by the first instance of the mask generator 808 to be relevant.

The view transform architecture 810 can receive the training mask, the offset condition, and the sensor features from the encoder 804. Based on the training mask and offset condition, the view transform architecture 810 can transform the sensor data into a second set of aerial view features (e.g., a second set of BEV features). The second set of aerial view features is a subset of aerial view features from the first set.

The view transform architecture 810 outputs the second set of aerial view features to a second instance of the mask generator 812. The second instance of the mask generator generates the second mask and a second offset condition based on the second set of aerial view features.

The second mask is provided to a motion compensator 814 to adjust the second mask based on motion of the device associated with sensor data.

The training process includes receiving additional sensor data 816 associated with time step t. The process includes providing the additional sensor data to encoder 818. In some examples, the encoder 818 is the same encoder as encoder 804. In some examples, the view transform architecture of 806 810 and 820 are the same. The encoder 818 processes the additional sensor data to generate (or extract) additional sensor features representing the additional sensor data.

View transform architecture 820 receives the additional sensor features, the adjusted second mask from the motion compensator, and the second offset condition. Based on the additional sensor features, the adjusted second mask, and the second offset condition, the view transform architecture 820 generates a third set of aerial view features (e.g., a third set of BEV features). The third set of aerial view features are received by task specific heads (e.g., task specific applications, programs) to perform a task. For example, the task can include ADAS functions such as object detection, automatic parking assistance, etc.

The training process includes comparing the training mask and the second mask to determine similarity losses (e.g., differences in the aerial view features that were included within the BEV grid) and sparsity losses (e.g., the number of zeroes in a mask, compared to a desired sparsity level). For example, the similarity loss can represent differences between a mask generated based on all of the aerial features and a mask generated based on the masked aerial view features. In some examples, the similarity loss can be the L2 norm of the differences between the training mask and the second mask. Sparsity loss can be used to enforce a degree of sparsity of masks (i.e., how many zeroes there are in the mask). Sparsity losses can be applied to masks individually. The training process can also include comparing losses or errors in the task that was to be performed using masks. For example, the training process can include comparing a loss term of the training mask and a loss term of the second mask. The training mask and the second mask can be compared using a loss function. The comparison can include appending regularization loss terms associated with mask similarity losses and loss terms associated with a task to be performed (e.g., tasks performed by task specific heads 822). An example loss function can include L=Lₜₐₛₖ+λ∥trainingmask−mask∥₂+φLₘₐₛₖ(mask)+ξLₘₐₛₖ(trainingmask) with L representing a total loss value of differences between the training mask and the second mask. Lₜₐₛₖ represents losses associated with the task to be performed by the device or task specific heads 822 (e.g., a semantic segmentation head can use a cross entropy loss, etc.) which can be used to train the task specific heads 822. Elements λ, φ, ξ represent loss weights for the similarity losses between the training mask and the second mask, and for mask sparsity losses. Lₘₐₛₖ(x) represents losses associated with an input mask, such as the training mask and the second mask. Lₘₐₛₖ(x) can be defined as

$${L}_{mask} ( x ) = \vert d - \frac{1}{N} {\sum }_{i} \frac{1}{1 + {e}^{- {x}_{i}}} \vert$$

with d representing the density of the input mask.

In some aspects, training of one or more of the machine learning systems or neural networks described herein (e.g., such as the neural networks of FIGS. 3A-3D and FIG. 4, among various other machine learning networks described herein) can be performed using online training (e.g., in some case on-device training), offline training, and/or various combinations of online and offline training. In some cases, online can refer to time periods during which the input data (e.g., such as the sensor data, images, masks) is processed, for example optimizing loss weights of the loss function to reduce losses while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model. The machine learning systems can be trained using a virtual BEV map (e.g., the virtual BEV map 900 of FIG. 9). The machine learning system can be trained to infer a subregion of the virtual BEV map to infer a subregion of the virtual BEV map that is relevant for a current scene (e.g., a scene captured by a camera) based on sensor input (e.g., a camera, optical sensor, etc.) The model can be trained to infer a mask for the subregion specifying which cells of the virtual BEV map are relevant to the current scene.

FIG. 9 is a block diagram of a virtual BEV map 900 with an applied mask (e.g., the virtual BEV map of the view transform architecture 806 and the input to the mask generator 808). The mask is represented by the shading of cells. The BEV map 900 is an aerial view representation of an environment in which a device 906 is located. By way of example, device 906 is represented as an icon on the BEV map 900. In FIG. 9, the virtual BEV map 900 is represented as a virtual BEV grid 902. The virtual BEV grid 902 is divided into various cells representing locations within the environment in which the device 906 is located. The virtual BEV grid 902 includes aerial view features associated with sensor data encompassing an entire detection range of the sensors. Not every aerial view feature is relevant for tasks to be performed by the device 906. The virtual BEV grid 902 includes a relevant region 904. For example, aerial view features in locations that are occluded or inaccessible by the device can be irrelevant. Irrelevant sub-regions within the environment are shown as irrelevant by the shading in the cells. For example, FIG. 9 shows a mask applied to the virtual BEV grid 902 indicating irrelevant locations. The relevant region 904 includes aerial view features associated with the relevant locations.

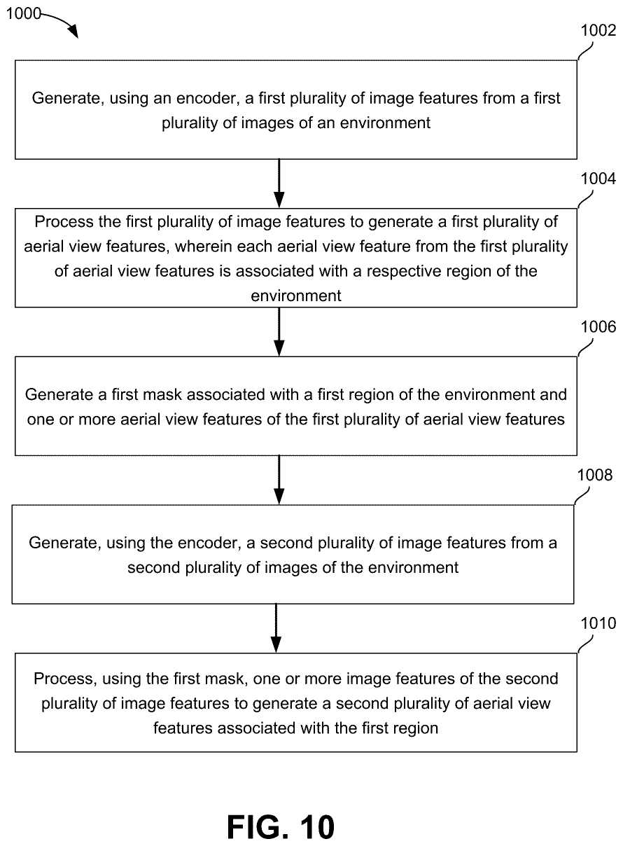

FIG. 10 is a flow diagram illustrating an example of a process 1000 for dynamic adjustment of adaptive feature maps (e.g., birds eye view (BEV) feature map(s)). The process 1000 can be performed by a computing device (e.g., system 100 of FIG. 1, computing device or computing system 1100 of FIG. 11, etc.) or by a component or system (e.g., the neural networks of FIGS. 3A-3D and FIG. 4, a chipset, one or more processors central processing units (CPUs), digital signal processors (DSPs), graphics processing units (GPUs), any other type of processor(s), any combination thereof, or other component or system) of the computing device. The operations of the process 1000 can be implemented as software components that are executed and run on one or more processors (e.g., processor 1110 of FIG. 11 or other processor(s)) of the computing device. Further, the transmission and reception of signals by the computing device in the process 1000 can be enabled, for example, by one or more antennas and/or one or more transceivers (e.g., wireless transceiver(s)).

At block 1002, the computing device (or component thereof) can generate a first plurality of image features from a first plurality of images of an environment. For example, the computing device can use an encoder (e.g., the camera encoder 704 of FIG. 7) to generate the first plurality of image features. The image features can be associated with images captured by a camera of the computing device. In further examples, the image features can be received from another computing device associated with one or more cameras. For example, the computing device can be part of an autonomous or semi-autonomous vehicle such as the vehicle 502 of FIG. 5. The cameras can be part of the sensor suite 504 of FIG. 5.

At block 1004, the computing device (or component thereof) can process the first plurality of image features to generate a first plurality of aerial view features. Each aerial view feature from the first plurality of aerial view features can be associated with a respective region of the environment. For example, aerial view features can be of objects within the environment captured by the sensors (e.g., the sensor suite 504 of FIG. 5). In one such example, where the computing device is part of a vehicle (e.g., the vehicle 502 of FIG. 5), a first aerial view feature can be an aerial view representation of a car to the left of the vehicle and a second aerial view feature can be an aerial view representation of a tree to the right of the vehicle. The first aerial view feature can be associated with a first location (e.g., a first region), and the second aerial view feature can be associated with a second location (e.g., a second region).

At block 1006, the computing device (or component thereof) can generate a first mask associated with a first region of the environment and associated with one or more aerial view features of the first plurality of aerial view features. For example, the first mask can be represent that regions behind the first region are occluded or blocked by an object at the first region and associated with the first plurality of aerial view features. The mask can be a two-dimensional (2D) Boolean matrix with each cell of the Boolean matrix indicating whether aerial view features in a corresponding location of the environment should be generated for subsequent pluralities of image features (e.g., subsequent frames captured by a camera).

For example, a barrier can separate the vehicle from a parallel road. The first mask can be a Boolean matrix indicating that aerial features associated with objects beyond the barrier should not be generated for subsequent pluralities of image features.

At block 1008, the computing device (or component thereof) can generate a second plurality of image features from a second plurality of images of the environment. In some examples, the computing device receive images from a camera. The computing device can use the encoder from block 1002, or the camera encoder 704 of FIG. 7, to generate the second plurality of image features. The second plurality of image features can be associated with a subsequent image captured by the camera, or set of cameras, that captured the image associated with the first plurality of image features.

At block 1010, the computing device (or component thereof) can process, using the first mask, one or more image features of the second plurality of image features to generate a second plurality of aerial view features associated with the first region. The second plurality of aerial view features can include aerial view features of the first plurality of aerial view features in addition to aerial view features not part of the first plurality of aerial view features. For example, when computing device is part of a vehicle in motion, the aerial view features generated using the computing device can change based on the location of the vehicle.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1100 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 1100 also includes a connection 1105 that couples various system components including system memory 1115, such as read-only memory (ROM) 1120 and random-access memory (RAM) 1125 to processor 1110. Computing system 1100 can include a cache 1112 of high-speed memory connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 can essentially be a completely self-contained computing system, containing multiple cores or processors, a bus, memory controller, cache, etc. A multi-core processor can be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 can also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc. When the code that defines such software is executed by the processor 1110, the code causes the system to perform a function. In some aspects, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:

Aspect 1: An apparatus for sensor feature projection, the apparatus comprising: at least one memory; and at least one processor coupled to the at least one memory and configured to: generate, using an encoder, a first plurality of image features from a first plurality of images of an environment; process the first plurality of image features to generate a first plurality of aerial view features, wherein each aerial view feature from the first plurality of aerial view features is associated with a respective region of the environment; generate a first mask associated with a first region of the environment and one or more aerial view features of the first plurality of aerial view features; generate, using the encoder, a second plurality of image features from a second plurality of images of the environment; and process, using the first mask, one or more image features of the second plurality of image features to generate a second plurality of aerial view features associated with the first region.

Aspect 2: The apparatus of Aspect 1, wherein the first plurality of images is associated with a first time step, and the second plurality of images is associated with a second time step.

Aspect 3: The apparatus of any one of Aspects 1 to 2, wherein the first region of the environment is a rectangular area of the environment.

Aspect 4: The apparatus of any one of Aspects 1 to 3, wherein the at least one processor is configured to: translate or rotate the first mask, based on a motion of a vehicle, to align the first mask with the second plurality of image features.

Aspect 5: The apparatus of any one of Aspects 1 to 4, wherein the at least one processor is configured to: determine a second region from the one or more regions of the environment associated with one or more aerial view features from the second plurality of aerial view features; generate a second mask associated with the second region of the environment; generate, using the encoder, a third plurality of image features from a third plurality of images of the environment; and process, using the second mask, one or more image features of the third plurality of image features to generate a third plurality of aerial view features associated with the second region.

Aspect 6: The apparatus of any one of Aspects 1 to 5, wherein the at least one processor is configured to: determine the first region based on an offset condition.

Aspect 7: The apparatus of any one of Aspects 1 to 6, wherein the at least one processor is configured to determine the first region based on a view of the one or more aerial view features associated with the first region being occluded.

Aspect 8: The apparatus of any one of Aspects 1 to 7, wherein the at least one processor is configured to determine the second region using a machine learning model.

Aspect 9: The apparatus of any one of Aspects 1 to 8, wherein the at least one processor is configured to generate the first mask or the second mask using a machine learning model.

Aspect 10: The apparatus of Aspect 9, wherein the machine learning model is trained using a loss function for measuring differences between a training mask and a third mask, wherein the training mask is generated using a set of aerial view features and the third mask is generated using a subset of the set of aerial view features.

Aspect 11: The apparatus of Aspect 10, wherein the machine learning model is trained using on-device training.

Aspect 12: The apparatus of any one of Aspects 1 to 11, wherein the at least one processor is configured to transform the second plurality of image features based on the first mask and an offset condition.

Aspect 13: An apparatus for sensor feature projection, the apparatus comprising: at least one memory; and at least one processor coupled to the at least one memory and configured to: generate, using an encoder, a first plurality of image features from a first plurality of images of an environment; process the first plurality of image features to generate a first plurality of aerial view features; generate a first aerial view grid associated with the first plurality of aerial view features; and determine, based on an offset condition, a section of the first aerial view grid relevant to a vehicle associated with the apparatus to generate a second aerial view grid based on the section of the first aerial view grid.

Aspect 14: The apparatus of Aspect 13, wherein the at least one processor is configured to adjust the offset condition based on a velocity of the vehicle.

Aspect 15: A method for sensor feature projection, the method comprising: generating, using an encoder, a first plurality of image features from a first plurality of images of an environment; processing the first plurality of image features to generate a first plurality of aerial view features, wherein each aerial view feature from the first plurality of aerial view features is associated with a respective region of the environment; generating a first mask associated with a first region of the environment and one or more aerial view features of the first plurality of aerial view features; generating, using the encoder, a second plurality of image features from a second plurality of images of the environment; and processing, using the first mask, one or more image features of the second plurality of image features to generate a second plurality of aerial view features associated with the first region.

Aspect 16: The method of Aspect 15, wherein the first plurality of images is associated with a first time step, and the second plurality of images is associated with a second time step.

Aspect 17: The method of any one of Aspects 15 to 16, wherein the first region of the environment is a rectangular area of the environment.

Aspect 18: The method of any one of Aspects 15 to 17, further comprising: translating or rotating the first mask, based on a motion of a vehicle, to align the first mask with the second plurality of image features.

Aspect 19: The method of any one of Aspects 15 to 18, further comprising: determining a second region from the one or more regions of the environment associated with one or more aerial view features from the second plurality of aerial view features; generating a second mask associated with the second region of the environment; generating, using the encoder, a third plurality of image features from a third plurality of images of the environment; and processing, using the second mask, one or more image features of the third plurality of image features to generate a third plurality of aerial view features associated with the second region.

Aspect 20: The method of any one of Aspects 15 to 19, further comprising: determining the first region based on an offset condition.

Aspect 21: The method of any one of Aspects 15 to 20, further comprising: determining the first region based on a view of the one or more aerial view features associated with the first region being occluded.

Aspect 22: The method of any of Aspects 19 to 21, further comprising: determining the second region using a machine learning model.

Aspect 23: The method of any of Aspects 19 to 22, further comprising: generating the first mask or the second mask using a machine learning model.

Aspect 24: The method of Aspect 23, wherein the machine learning model is trained using a loss function for measuring differences between a training mask and a third mask, wherein the training mask is generated using a set of aerial view features and the third mask is generated using a subset of the set of aerial view features.

Aspect 25: The method of any of Aspects 23 to 24, wherein the machine learning model is trained using on-device training.

Aspect 26: The method of any of Aspects 15 to 25, further comprising: transforming the second plurality of image features based on the first mask and an offset condition.

Aspect 27: A method for sensor feature projection comprising: generating, using an encoder, a first plurality of image features from a first plurality of images of an environment; processing the first plurality of image features to generate a first plurality of aerial view features; generating a first aerial view grid associated with the first plurality of aerial view features; and determining, based on an offset condition, a section of the first aerial view grid relevant to a vehicle associated with the apparatus to generate a second aerial view grid based on the section of the first aerial view grid.

Aspect 28: The method of Aspect 27, further comprising: adjusting the offset condition based on a velocity of the vehicle.

Aspect 29: An apparatus for sensor feature projection is provided. The apparatus includes one or more means for performing operations according to any of Aspects 1 to 14.

Aspect 30: A non-transitory computer-readable medium is provided having stored thereon instructions that, when executed by at least one processor, cause the at least one processor to perform operations according to any of Aspects 15 to 28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for sensor feature projection, the apparatus comprising:
at least one memory; and
at least one processor coupled to the at least one memory and configured to:
generate, using an encoder, a first plurality of image features from a first plurality of images of an environment;
process the first plurality of image features to generate a first plurality of aerial view features, wherein each aerial view feature from the first plurality of aerial view features is associated with a respective region of the environment;
generate a first mask associated with a first region of the environment and one or more aerial view features of the first plurality of aerial view features;
generate, using the encoder, a second plurality of image features from a second plurality of images of the environment; and
process, using the first mask, one or more image features of the second plurality of image features to generate a second plurality of aerial view features associated with the first region.

2. The apparatus of claim 1, wherein the first plurality of images is associated with a first time step, and the second plurality of images is associated with a second time step.

3. The apparatus of claim 1, wherein the first region of the environment is a rectangular area of the environment.

4. The apparatus of claim 1, wherein the at least one processor is configured to:
translate or rotate the first mask, based on a motion of a vehicle, to align the first mask with the second plurality of aerial view features.

5. The apparatus of claim 1, wherein the at least one processor is configured to:
determine a second region of the environment associated with one or more aerial view features from the second plurality of aerial view features;
generate a second mask associated with the second region of the environment;
generate, using the encoder, a third plurality of image features from a third plurality of images of the environment; and
process, using the second mask, one or more image features of the third plurality of image features to generate a third plurality of aerial view features associated with the second region.

6. The apparatus of claim 5, wherein the at least one processor is configured to:
determine the first region based on an offset condition.

7. The apparatus of claim 5, wherein the at least one processor is configured to determine the first region based on a view of the one or more aerial view features associated with the first region being occluded.

8. The apparatus of claim 5, wherein the at least one processor is configured to determine the second region using a machine learning model.

9. The apparatus of claim 5, wherein the at least one processor is configured to generate the first mask or the second mask using a machine learning model.

10. The apparatus of claim 9, wherein the machine learning model is trained using a loss function for measuring differences between a training mask and a third mask, wherein the training mask is generated using a set of aerial view features and the third mask is generated using a subset of the set of aerial view features.

11. The apparatus of claim 10, wherein the machine learning model is trained using on-device training.

12. The apparatus of claim 1, wherein the at least one processor is configured to transform the second plurality of image features based on the first mask and an offset condition.

13. An apparatus for sensor feature projection, the apparatus comprising:
at least one memory; and
at least one processor coupled to the at least one memory and configured to:
generate, using an encoder, a first plurality of image features from a first plurality of images of an environment;
process the first plurality of image features to generate a first plurality of aerial view features;
generate a first aerial view grid associated with the first plurality of aerial view features; and
determine, based on an offset condition, a section of the first aerial view grid relevant to a vehicle associated with the apparatus to generate a second aerial view grid based on the section of the first aerial view grid.

14. The apparatus of claim 13, wherein the at least one processor is configured to adjust the offset condition based on a velocity of the vehicle.

15. A method for sensor feature projection, the method comprising:
generating, using an encoder, a first plurality of image features from a first plurality of images of an environment;
processing the first plurality of image features to generate a first plurality of aerial view features, wherein each aerial view feature from the first plurality of aerial view features is associated with a respective region of the environment;
generating a first mask associated with a first region of the environment and one or more aerial view features of the first plurality of aerial view features;
generating, using the encoder, a second plurality of image features from a second plurality of images of the environment; and
processing, using the first mask, one or more image features of the second plurality of image features to generate a second plurality of aerial view features associated with the first region.

16. The method of claim 15, wherein the first plurality of images is associated with a first time step, and the second plurality of images is associated with a second time step.

17. The method of claim 15, wherein the first region of the environment is a rectangular area of the environment.

18. The method of claim 15, further comprising:
translating or rotating the first mask, based on a motion of a vehicle, to align the first mask with the second plurality of image features.

19. The method of claim 15, further comprising:
determining a second region of the environment associated with one or more aerial view features from the second plurality of aerial view features;
generating a second mask associated with the second region of the environment;
generating, using the encoder, a third plurality of image features from a third plurality of images of the environment; and
processing, using the second mask, one or more image features of the third plurality of image features to generate a third plurality of aerial view features associated with the second region.

20. The method of claim 19, further comprising:
determining the first region based on an offset condition.
